(19) United States
(12) Patent Application Publication
(10) Pub. No.: US 2005/0118222 A1
(43) Pub. Date: Jun. 2, 2005

(54) Product to combat ticks and the process for the product's preparation

(76) Inventor: Bruce Zbig Aken Wolff, Rio de Janeiro (BR)

Correspondence Address: COLLEN IP, THE HOLYOKE MANHATTAN BUILDING, 80 SOUTH HIGHLAND AVENUE, OSSINING, NY, 10562, US

(21) Appl. No.: 10/639,644

(22) Filed: Aug. 12, 2003

(30) Foreign Application Priority Data
Aug. 12, 2002 (UY) 27412

(51) Int. Cl. A01N 43/04; A01N 25/00

(52) U.S. Cl. 424/405; 514/28

(57) ABSTRACT

The object of the invention of this patent is a new product and the method for its manufacturing, intended for the world's veterinary market, especially for those regions infested by ticks. Its main activity consists of simultaneously carrying, by means of an injection, a state of the art macrocyclic lactone and an antigen against ticks. The main advantage of the product consists of the reduction of the drug dose on account of its injectable presentation, without it being affected by the problems associated to the external use presentation. Moreover, the drug is a slow release drug, which allows the existence of longer intervals between applications. Finally, the product's continuous use will generate a specific immunity against ticks, thus controlling the plague in rural premises.

The present invention refers to pharmaceutical-biological compositions, more particularly to a new product and the process for its manufacturing, intended for the veterinary market to combat ticks in the bovine herds of the world's tropical and sub-tropical regions, characterized in that its activity is based on a novel oily vehicle which allows to solubilize the world's first injectable Eprinomectin with specific tick antigens. It refers to an injectable endo- and ectoparasiticide, with biological activity against tick infestations. While Eprinomectin acts with all its endectocide pharmaceutical potential, the specific antigens implement gradual immunity against ticks. Therefore, it is an endectocide agent, which provides combined pharmaceutical and biological activity.

About Ticks and the Protecting Antigen

The Boophilus microplus tick is the most significant ectoparasite in bovines due to its wide geographic expansion, appearing in all the world's tropical and sub-tropical regions, between latitudes 32° South and 40° North. Morbidity and mortality are caused by its hematophagous nature and by the hemotropic pathogenic agents it transmits, this being one of the major problems in bovine livestock. (Hernández, 1997).

The classic tick control method, which advocates the systematic use of miticides, brings about other inconveniences, apart from the fact that the use of these chemical products results in the development of stronger strains. Thus, constant treatment is necessary. The frequency with which cattle has to be gathered results in a reduction of the herd's productive performance (Montero, page 6), not to mention the toxicity of miticides, which affects animal and human health and causes environmental damage (Valle, page 22). The use of these products has been the main B. microplus control measure taken hitherto, for, since the 50s, the object of the establishment of strategic controls, sustaining the simulation of population models, has been the minimal use of chemical products, in order to avoid the development of resistant strains and keep reduced tick populations, without breaking the immunological stability, against the etiological agents of cattle babesiosis and anaplasmosis. (Hernández, 1997).

The first signals of Boophilus microplus resistance to arsenical pesticides were detected by the end of the 30s in South American, African and Australian countries. During the following decades, other active ingredients (organophosphate, carbamate, piretroid and amidine) were introduced in the fight against ticks, always with a constant development of resistance to these chemical products. According to the FAO, at present, in more than 24 countries, B. microplus is resistant to the available miticides. In Cuba, B. microplus' resistance to organophosphate pesticides was described for the first time in 1976 and at present it is also resistant to amidine. (Mario Valdéz, page 9).

Some animals, after repeated tick infestations, present an acquired resistance which varies depending on the bovine breed. Therefore, this resistance may be considered as a natural immunological control method, which is nevertheless generally insufficient to control infestations.

The predominant feature of the State of Rio de Janeiro's cattle, which is constituted of crossed Holstein Friesian and zebu livestock, the latter possessing a natural immunity to ticks, halfway between European and Asian cattle's, is favorable for the utilization of the recombinant vaccine as a tick control means (Valle, 2001).

Alternative tick control methods have been used, such as the introduction in grazing lands of leguminosae capable of killing tick larvae; some other methods, such as: the use of sterile male ticks, achieved by inter-species crossing (OSBURN & KNIPLING, 1982) and biological control using predators and pathogenic microorganisms (BRUM et al., 1992; BITTENCOURT et al., 1994) need a better technical and scientific assessment in order to be approved as alternative control measures.

Miticide chemical products have been used as the main measure to control B. microplus. Sometimes, they produce a quick and efficient mortality during the phases in which the parasite is on the animal. However, their activity on larvae lying on the grass is sometimes limited (MONTERO et al., 2001).

In isolation, such measures have not brought forth any enhancements allowing for the reduction of costs and bovine livestock loss. At the same time, the problems of environmental damage and cross-resistance in tick populations, which frequently occur due to the empirical use of these products, cannot be avoided (Hernández, 1997).

While assessing miticide treatments based on pour-on, injectable and intraruminal avermectin, CARDOZO et al. (1994) developed significant comments on how to use the studied product, asserting that undue use could render them inefficient.

MONTERO et al. (2001) confirmed the existence of a significant limitation in the use of chemical products regarding the development of B. microplus resistant strains. Thus, a relationship exists between the development of tick control chemical products and the development of strains which resist them.

The beginning of the tick's feeding process on an animal who was never exposed to an infestation by this parasite, is characterized by the recognition of salivary immunogens by cells of the epidermis and dermis, which concentrate on the place of the bite. The type of the introduced immunogen varies according to the phase of the parasite's biologic cycle (Valle, 2001). Proteins and other immunogenic molecules present in the tick's saliva may be processed by Langerhans cells and macrophages, or by dendritic cells, and they are finally introduced into the secondary lymphatic organs and T lymphocytes. T lymphocytes recognize tick immunogens and histocompatibility complexes in antigen-presenting cells. The activated T lymphocytes (helper 1 and helper 2) will release lymphokines that will work as immunity regulators, allowing the generation of the response mediated by cells and antibodies (Mossman & Coffman, 1989). T lymphocytes still influence retarded hypersensitivity reactions, including the cutaneous hypersensitivity response due to basophil infiltration occurring during the tick's feeding process (Willadsen, 1980; Dvorack et al., 1970). Immunogens, antigen-presenting cells, T lymphocytes and cytokines, all contribute to the activation of B lymphocytes, which will produce the antibodies that will act against ticks. The parasite's primary response is to inhibit the hypersensitivity response and the reaction of the host's antibodies. Meanwhile, more information is necessary to understand the interaction between the host's defenses and the tick (Valle, 2001).

When introduced into the skin of an insensitive host, the tick's saliva causes mastocyte and basophil degranulation, possibly through the enzymatic hydrolysis produced by salivary enzymes (Allen, 1979; Kemp & Bourne, 1980). Therefore, chemostatic and vasoactive factors are released, which may contribute to the slight leukocyte influence observed in the tick binding spots during the animal's first exposures (Sauer, 1995). C5a formation arising from the complement alternate pathway, may also contribute to cell influence on the spot (Roberts & Kerr, 1976).

Ticks may modulate the host's natural and acquired response because this parasite's saliva possesses complement alternate pathway, anaphylatoxin and adenine cell inhibitors. Moreover, tick saliva reduces the formation of cytokines by the macrophage, which is significant in the initial response against ticks.

Repeated exposure to the parasite allows ticks to come into contact with the elements of the host's immune response; then, the salivary immunogens stimulate the memory response of T and B lymphocytes.

In resistant animals, basophils and histamines are attracted to the tick-host binding spot, by mediators and T lymphocytes. Thus, the complement is activated by the alternate or classic pathway, by the presence of the antibody bound to the antigen, and the basophils and mastocytes degranulate when the antigen/antibody complex occupies the cell receptor.

In acquired immunity, the specific mechanisms which interrupt the feeding process and reduce egg laying are poorly known.

Antigens related to acquired immunity (natural), are usually those appearing in the portions of the parasite which are directly bound to the host. This relationship many times renders the use of that antigen in artificial immunization not effective, due to the adaptations which occur during the evolution of the host/parasite relationship. During the last few years, the use new antigens to artificially induce host's immunity has been sought. These antigens, called “hidden”, do not participate directly in the host/parasite interaction (Valle, 2001). For example, Schlein & Lewis (1976) vaccinated rabbits with muscular tissue of the Stomoxys calcitrans fly and observed that they showed muscular lesions after they were fed.

The first suggestion for the utilization of new antigens for animal immunization against ticks was proposed by Galun (1975). GALUN's observations indicated the possibility of producing vaccines against B. microplus employing the new functional antigens—also called hidden antigens-, which may be classified as those molecules of physiological significance for the parasite and which are normally alien to the host/parasite interaction.

Several Boophilus microplus hidden antigens were isolated. The more known of them was the Bm86 antigen, a membrane surface glycoprotein of the digestive cells of the midgut of B. microplus nymphs. The molecular weight of the Bm86 protein has been determined at 89000 D and its isoelectric point ranges between 5,1 and 5,6 (Hernandez, 1997).

RAND et al. (1989), isolated cDNA clones related to the Bm86 glycoprotein, which were purified and homogenized.

RODRIGUEZ et al. (1994), through radioimmunoassay and cDNA-PCR techniques, also isolated and amplified the gene which codifies the B. microplus Bm86 antigen, expressing it in several systems, including P. pastoris methylotrophic yeast. This expression caused an increase of the immunogenic potential, since the molecule is secreted in the glycosylated form, thus originating 20-36 nm diameter particles, also called recombinant antigen particles—rBm86. The Bm86 protein kept its immunogenic capacity when it was obtained through the recombinant pathway, thus enabling the production of commercial vaccines.

The commercial vaccine was then manufactured on a large scale, using P. pastoris yeast, wherein the Bm86 protein codifying gene was introduced (Montero, page 7).

The vaccine is capable of inducing an immunological response which allows to keep parasites under control, with the perspective of a longer protection period and without the environmental problems caused by chemical miticides.

The effect on ticks parasitizing vaccinated bovines has been histologically studied, and a rupture of the tick's digestive cells, followed by the penetration of host's cells in the parasite's hemolymph was observed, but no damage to the salivary tissues was perceived. Vaccination causes expressive lesions to the parasite during the adult phase, but in larval phases, the damage is not so significant, generally causing a slight retard in nymph development (Valle, 2001).

At present, it is known that the complement system has an essential function in the immune response against the mucous antigen, and that it causes some of the lesions in the ticks' intestine. The significance of the complement's participation in the degenerative events occurring in the parasite's intestine was proved when it was verified that ticks fed with bovine serum of complement-free, vaccinated animals, did not present the characteristic lesions (Coons et al., 1988). The intestine cells damaged by the vaccine are digestive cells, the essential function of which is to carry out blood endocytosis and intracellular digestion, which is the main food of ticks (Hamilton et al., 1991).

The activity mechanism of the Bm86 vaccine antigen in ticks may be summarized as follows: the vaccinated animal's blood contains high levels of antibodies and other elements that mediate the immune response, such as complement. When the blood of the vaccinated bovine is ingested by the tick, the specific antibodies bind themselves to the antigen, and in this case, to the surface of the parasite's digestive cells, where it causes serious morphological and physiological damage. The more frequently observed morphological alterations in engorged ticks on immunized animals are: alterations in the conformation an color, the parasite's body flattens and reddens due to the rupture of the accessory gland of the reproductive organs. These damages are reflected in the reduction of the number and size of the fed nymphs; reduction of egg-laying and of egg fertility; which provokes a drop in the ticks' reproductive potential in successive generations and leads to the reduction of populations in pastures (COBON et al., 1995; RODRIGUEZ et al., 1995b).

In an experience carried out with picketed Holstein Friesian and crossbred cattle in the field, RODRIGUEZ et al. (1995a) observed a significant reduction of the number of engorged female ticks on hosts during a 36-week challenge, and concluded that the recombinant antigen in P. pastoris, called GAVAC™, may be adequate to control B. microplus populations in successive generations in pastures.

VANEGAS et al. (1995), observed that the systematic immunization of bovines, with rBm86 vaccine antigens, reduced the number of miticide treatments in the herd, as well as the incidence of hemo-parasitosis.

RODRIGUEZ et al. (1995a) in a test under controlled conditions, using rBm86 against two B. microplus Mexican strains: Mora and Tuxpan, which are resistant to organophosphate and piretroid miticides, observed a decrease in the number of ticks on hosts, obtaining a 56% to 58% efficacy, respectively. The authors indicated that at first they did not observe any differences regarding the number of ticks between the vaccinated animals and the control animals, nor regarding their morphology and appearance, until between 48 and 58 days after the first dose, for the Tuxpan and Mora strains, respectively.

In a barn test, MASSARD et al. (1995a), obtained 40% results in the reduction of the number of engorged female ticks in vaccinated animals in relation to the control group. Other assessed parameters were: nymphs' weight reduction (6.2%); egg-laying reduction (8.0%); and egg fertility reduction (10.0%). Considering the different verified rates, the integral efficacy of this antigen against the B. microplus Brazilian strain, reached 51%.

RODRIGUEZ et al. (1995b) observed that the vaccine reduced tick infestations in the studied herds, notwithstanding some variations in the immune response of animals on the field, depending on the region, breed, individual and climatic factors.

In the work carried out by Valle (2001) in Cuba, it was possible to reduce the number of tickicide baths from 26 per year in 1997, to 2.5 per year in 2000. The same work reports that the cost with miticides was reduced from 208 liters the first year (1997), to 22 liters by the last assessment year (2000).

A significant effect observed throughout the whole experimental treatment is the significant reduction of the incidence of Babesiosis (MONTERO et al., 2001).

About Eprinomectin

Eprinomectin, (4″R)-4″-epi(Acetylamino)-4″-deoxyavermectin B1, is a semi-synthetic derivative of the avermectin family, originated through the fermentation of Streptomyces avermectilis strains; its basic structure consists of a 16 member macrocyclic lactone, wherein C-17 and C-25 are bound to a spiroacetal group, C-2 and C-8 are bound to an hexahydrofurane unit, and which comprises sugar—a disaccharide—in the C-13 position. (Raymond J. Cvetovich, Dennis H. Kelly, Lisa M. DiMichele, Richard F. Shuman and Edward J. J. Grabowski. Syntesis of 4″-epi-Amino-4″deoxyavermectins B1. J. Org. Chem. 1994, 59, 7704-7708).

Eprinomectin is a mixture of two homologues, eprinomectin B1a (90%) and eprinomectin B1b (10%), the difference between them being the existence of a methylene group in C-25.

These structures possess a wide activity spectrum against nematodes and anthropods and their effectiveness against both endo- and ectoparasites has led them to be called endectocides. Eprinomectin is a state of the art endectocide molecule.

The pharmaceutical activity of these molecules increases the permeability of the parasite's muscle and nervous cells to chlorine ions, thus causing the parasite's paralyzation and death. The molecule binds itself to the glutamate-controlled chlorine channels, which is a characteristic of invertebrates' cells. They may also bind themselves to other GABA-controlled chlorine channels. Since mammals do not possess this type of glutamate-controlled chlorine channel, these macrocyclic lactones provide a high degree of safety, even at triplicated doses.

Products based on Eprinomectin available in the market are for external use: a 0.5% w/v (0.5 g in 100 ml) Eprinomectin solution is poured over the skin of the animal's back in doses of 0.5 mg/kg, w.v. (0.1 ml/10 kg, w/v). This application method is known as “pour-on”.

The external or pour-on method has some advantages in what regards the applicator's safety, but it is also largely affected by several factors which may reduce its efficacy due to the imprecision of its dosage, such as:
The animal's fur, the condition of the skin, the presence of burns, crusts or other problems may affect the cutaneous absorption of the active ingredient, therefore causing an adverse effect on its efficacy as a drug.
External application suffers adverse effects due to environmental factors in areas of drought, where animals have many dust particles on their backs (frequently seen in areas of prolonged droughts), or if they have mud or dung on their backs. In tropical or sub-tropical regions, with sudden climatic changes, including the eventuality of downpours following the application, adsorption efficacy may be affected, as well as on days of strong solar radiation where the product may crystallize on the animal's back, even before the cutaneous absorption process begins.

All these adverse conditions make it compulsory to more than double the necessary quantity of drug in order to combat the parasite. This high supplementary addition of active ingredient has economic consequences regarding the cost per treated animal and may have a certain impact on the rural environment.

During the search for a molecule with endectocide activity and at the same time not eliminated through milk fat in production animals, there arose a series of studies that culminated with the achievement of Eprinomectin.

First, the works of Shoop, Demontigny et al., in 1996, demonstrated that avermectin/milbemycin molecules could be manipulated to enhance their activity or reduce the partition coefficient (milk/plasma) in dairy animals during the production period.

Later on, several molecules presenting unsaturated C-22,23 were investigated, and finally, molecules with unsaturated analogical C-4 epi-amino in C-22,23 were studied. It was precisely this subgroup which showed lower milk/plasma ratios. Therefore, the molecule was called 4-epi-acetylamino, 4-desoxy avermectin B1.

In 1999, Alvinerie et al., concluded that only 0.1% of the applied drug was eliminated through the milk. That is to say, 50 times less when compared to ivermectin or moxidectin.

Initially launched to the market for external use, 500 μg/kg of live-weight Eprinomectin is now available for the first time in subcutaneous or intramuscular injectable presentation, on account of the development of a novel vehicle which, apart from promoting enhancements in the molecule's pharmacokinetics and bioavailability, it allows to associate two specific antigens against Boophilus microplus.

Injectable Eprinomectin acts more efficiently, showing higher bioavailability and thus, expressing all its endectocide strength, acting against: gastrointestinal and lung worms; dermatobia hominis; sucking and biting lice; chorioptic and sarcoptic mites; horn fly and ticks.

Its mixed, pharmaceutical and vaccinal activity determines that animals remain clear of internal and external parasites (mainly ticks) and, with time, successive applications determine a gradual protective immunity, which will allow longer intervals between treatments and cause a dramatic decrease in tick infestations.

The extension of time periods between treatments will show a substantial reduction of the quantity of drug necessary to guarantee control.

The addition of specific antigens, obtained from tick intestinal proteins and sequenced by genetic engineering in standardized yeast strains, carried in a special injectable vehicle, will gradually implement an immunity against ticks, allowing to achieve a typical control status in a two-year term, without the complete elimination of the parasite.

This situation is the most desirable because it solves the problems of this insidious infestation without animals losing their pre-immunization against diseases transmitted by ticks (babesiosis and anaplasmosis). This fact will allow to transport and carry treated animals from controlled areas to endemic non-treated areas, without the risk of their suffering from “hemolitic shock”.

The product is destined to combat internal and external parasites in breeding and dairy herds of the world's tropical and subtropical regions infested by ticks.

Eprinomectin, now diluted in a special injectable vehicle, shall have a 50% lower drug dose per live-weight kilogram, compared to the original external use formulation.
Injectable presentation: from 200 to 250 μg/kg of live-weight
External use presentation: 500 μg/kg of live-weight

The molecule allows for a zero elimination period through the milk and meat of the treated animals. Moreover, this molecule does not affect the environment, since the product is rapidly neutralized on the ground when it binds itself to soil particles.

Its elimination occurs fundamentally through dung (85%) and it has been proved that it does not affect the manure-processing insect and coleopterous flora in the soil.

About the Vehicle

The new product, which is the object of this invention is the result of the development of a novel injectable vehicle, which is simultaneously able to solubilize doses of up to 0.5% to 3.5% of Eprinomectin and provide 2 specific antigens that with time, induce an active and gradual immunity in animals against ticks.

The special injectable vehicle is an oil associated to derivatives of amino-alcohols, esters and surfactants.

The esters and surfactants allow to mix the combination of Eprinomectin and antigens against ticks with the oil, thus obtaining a stable emulsion on account of the hydrophilic-lipophilic balance of the different components. The addition of amino-alcohols provides additional thermodynamic stability to the emulsion, at preservation temperature (from +2° C. to +4° C.) of the pharmaceutical and biological composition.

This invention provides a vehicle, the composition of which contains the following ingredients:
a) Oily matrix: highly purified mineral, plant or animal oil; this component may be present in the formulation in a 60% to 75% ratio (weight per volume percentages wlv)
b) A surfactant or a mixture of non-ionic surfactants, such as polyoxyethylated or non-polyoxyethylated sorbitan esters, polyoxyethylated alkyl esters, polyoxyethylated castor oil derivatives, polyglycerol esters, polyoxyethylated fatty alcohols. The surfactants shall be added to the oil in such quantities that assure that, once the emulsion has been formed with the aqueous phase, it will remain stable through time. It is proposed for the mixture of surfactants to possess a 5.3 HLB and that it be present in the formulation at a concentration between 9% and 12% w/v (weight per volume percentages w/v).
d) Organic additive: present in the formulation for the better performance of the elaborated emulsion. Seriated experiments were carried out for the selection of this ingredient, using different chemical molecules, among which there were: Triethanolamine, benzyl alcohol, Acetone, Dimethylformamide, Monoethyl ether, Propylenglycol, from which different emulsions were manufactured and then the stability of the same was observed at two different temperatures: 37° C. and 56° C. The preferred organic additive was triethanolamine in a concentration range of 0.1 to 0.05% (weight per volume percentages w/v).
e) An antioxidant or a mixture thereof, which may be Buthylhydroxyanisol or Buthylhydroxytoluene. The concentrations at which it appears in the formulation are the ones indicated in the pharmaceutical Pharmacopoeias or CFR 21.

The vehicle CHARACTERIZED in the foregoing paragraph provides the final product with the following immunogenic characteristics:
ACTION OF BODIES THAT ATTRACTS THE FIRST-LINE DEFENSE ELEMENTS TO THE INOCULATION SPOT (MAINLY MACROPHAGES).
SLOW RELEASE OF ACTIVE INGREDIENTS.
MIGRATION THROUGH LYMPHATIC PATHWAY CREATING OTHER REACTION CENTERS IN THE ENDOTHELIAL RETICULAR SYSTEM.

In the formula, the active ingredients: the drug: Eprinomectin, and the biological agent: antigens against ticks, both immerse in the vehicle, are slowly released. Thus, the drug's antiparasitic effect endures, due to its presence in the blood, despite the passage of time (Long Term Activity) and the implementation of immunity is gradual and sustained.

The implantation of this type of immunity is very complex and slow, it is the result of the booster effect of several consecutive applications.

After each application of the new product, the herd gradually increases its immunity against ticks. This resulting immunity allows for longer intervals between treatments and to reduce tick populations more each time. Summarizing, the administration of the new product reduces the need of treatments and stressing handling of herds.

Finally, for the purpose of avoiding iatrogenic disease transmission, the new product is available with a set of injection needles, in order to allow the use of one needle per animal.

This new product not only provides a more efficient injectable Eprinomectin—on account of the dose/effect combination-, but is also much more precise than the pour-on application method, since while it chemically eliminates ticks, it gradually prepares the animal to render it immune to parasites.

This invention provides a new injectable product which provides for safer application. Its application is more precise and, unlike its external use presentation, it is not affected by extreme climatic factors (strong solar radiation or rain downpours). While farmers chemically eliminate ticks, they are making their herd immune and thus, they are generating a control situation where tick populations will gradually diminish until they become innocuous and stop causing losses due to blood depletion, transmission of diseases or hide depreciation.

About the Product's Formulation Process

The invention also refers to a new process for the manufacturing of the new product, which comprises the following steps:

Adiuvant Phase—50° C. Temperature

Oil filtration for sterilization.

The mineral oil is added to the previously thermostated surfactants at 50° C. The whole mixture is homogenized at said temperature in absolutely dry sanitary tanks, under nitrogen atmosphere.

The product is injected under nitrogen pressure into the formulation tank and subjected to the filtration process through clarifying and sterilizing filtering cartridges with 0.22 milli-micron pores.

The sterile filtrate will be received in the previously sterilized, dry, stainless steel tank 316, with sanitary electropolish, under nitrogen atmosphere.

Thermostate at 40° C.—MIXTURE 1

Hydrosoluble Phase—4° C Temperature

The aqueous antigens formed by the suspensions of the protein recombinant material of the Boophilus microplus' digestive system, and obtained through bacterial fermentation, are added to the Eprinomectin solution. The Eprinomectin solution is prepared by the dilution of the drug in an hydrosoluble vehicle at a concentration that may range between 0.25% to 20% w/v (eprinomectin in hydrosoluble vehicle). Eprinomectin concentration in the final product shall be of 0.5%-3.5% w/v and the dose to be administered of the final product shall be of 200 to 250 μg of eprinomectin/kg of animal weight.

Once an homogeneous suspension is obtained, it is slowly placed under strong stirring over the oil and surfactant mixture 1 at +4° C.

The preliminary mixture is stirred for 2 hours in order to be later homogenized by the passage through colloidal mills or high pressure homogenizer of the GAULIN type.

The finished product shall be kept at +4° C. during its useful life period and bottled in ampoule-type bottles with profusion nitrilic rubber lids, with aluminum seal.

### SUMMARY OF THE INVENTION

An object of the present invention is to provide the injectable active ingredient Eprinomectin.

Eprinomectin (4-epi-acetylamino-4-desoxy avermectin B₁) is a state of the art molecule of the class of the macrocyclic lactoses.

This molecule has been initially launched to the market only for external use in a dose of 500 μg/kg of live-weight. The presentation proposed by Eprinovax determines a similar therapeutic activity in much lower doses: 200-250 μg/kg of live-weight.

Another object of this invention is to combine in one vehicle the Eprinomectin drug and the specific antigens against ticks. Thus, dairy or cattle producers, while delousing their animals, are also generating an immunity against ticks in their herds, which may last for a two-year period.

Moreover, another object of the invention is that the novel vehicle determines a slow release effect of the active ingredients, which will determine the existence of longer intervals between treatments.

An new object of the invention is to achieve a gradual decrease in the quantity of necessary insecticide drug to combat ticks, having a dramatic influence on all the environmental impacts caused by these products.

1. A pharmaceutical-biological product, or pharmaceutical vaccine, intended for the veterinary market, to combat ticks in the bovine herds of the world's tropical and sub-tropical regions, characterized in that its activity is based on a novel oily vehicle which allows to solubilize the world's first injectable Eprinomectin, in doses of 200-250 μg/kg of live-weight, with specific tick antigens, more specifically, in that its main activity is to simultaneously carry by means of an injection, a state of the art macrocyclic lactone and antigens against ticks.

2. The new product according to claim 1, characterized in that it is the result of the development of a novel injectable vehicle that can simultaneously solubilize doses ranging between 0.5% and 3.5% of Eprinomectin and provide 2 specific antigens that eventually generate an active and gradual immunity against ticks in animals.

3. The product according to claims 1 and 2, wherein the special injectable vehicle is an oil associated to esters and other surfactants, wherein these surfactants will allow to mix the Eprinomectin solution with the aqueous solution against ticks, thus obtaining a stable emulsion on account of the hydrophilic-lipophilic balance of the emulsion at the preservation temperature of the pharmaceutical and biological composition (+2° C. to +4° C.).

4. The product according to the invention comprises in its formulation a novel vehicle characterized by: a) An oily matrix constituted of highly purified oil at a concentration of 60-75% w/v; b) A surfactant, or a mixture of two surfactants, possessing a 5.3 HLB and which is present in the formulation at a concentration between 9 and 12% w/v; c) An organic additive, triethanolamine (TEA) at a concentration of 0.1 to 0.05% w/v; e) An antioxidant or a mixture thereof.

5. The product according to claim 4 comprises in its formulation a vehicle, the oily matrix of which a) is a mineral oil.

6. The product according to claim 4 comprises in its formulation a vehicle, the oily matrix of which a) is a plant oil.

7. The product according to claim 4, comprises in its formulation a vehicle, the oily matrix of which a) is an animal oil.

8. The product according to claim 4 comprises in its formulation a vehicle, the surfactant of which b) may be selected from the group consisting of: polyoxyethylated or non-polyoxyethylated sorbitan esters; polyoxyethylated alkyl esters; polyoxyethylated castor oil derivatives; polyglycerol esters and polyoxyethylated fatty alcohols.

9. The product according to claim 4 comprises in its formulation a vehicle, the antioxidant of which e) is buthylhydroxytoluene.

10. The product according to claim 4 comprises in its formulation a vehicle, the antioxidant of which e) is buthylhydroxyanisol.

11. The product according to claim 4 comprises in its formulation a vehicle, the antioxidant of which e) is a mixture of buthylhydroxyanisol and buthylhydroxytoluene in a 1:2 proportion.

12. A process for the preparation of the product, according to any one of claims 1 to 3, which comprises two phases, the first one being a phase at a 50° C. temperature and the second one being a phase at a +4° C. temperature.

13. A process for the preparation of the product according to claim 12, wherein the first phase consists of the following stages: Oil filtration for sterilization; the oil is added to the 50° C. thermostated surfactant agents, wherein the whole mixture is homogenized at said temperature in absolutely dry sanitary tanks, under nitrogen atmosphere; wherein, the product is introduced under nitrogen atmosphere into the formulation tank and subjected to the filtration process through clarifying and sterilizing filtering cartridges with 0.22 milli-micron pores; wherein the sterile filtrate will be received in the previously sterilized, dry, stainless steel tank 316, with sanitary electropolish, under nitrogen atmosphere.

14. A process for the preparation of the product, according to claim 12, wherein the second phase consists of the following stages: The aqueous antigens formed by the suspensions of the protein recombinant material of the Boophilus microplus' digestive system, and obtained through bacterial fermentation, are added to the Eprinomectin solution. The Eprinomectin solution is prepared by the dilution of the drug in an hydrosoluble vehicle at a concentration that may range between 0.25% to 20% w/v (eprinomectin in hydrosoluble vehicle). Eprinomectin concentration in the final product may be of 0.5%-3.5% w/v and the dose to be administered of the final product shall be of 200 to 250 μg of eprinomectin/kg of animal weight. Once an homogeneous suspension is obtained, it is slowly placed under strong stirring over the oil and surfactant mixture 1 at +4° C.

15. A process for the preparation of the product, according to claims 12, 13 and 14, wherein the preliminary mixture is stirred for 2 hours in order to later be homogenized by its passage through colloidal mills or high pressure homogenizer of the GAULIN type, wherein the finished product shall be kept at +4° C. during its useful life period and shall be bottled in ampoule-type bottles with profusion nitrilic rubber lids, with aluminum seal.
